(19) United States
(12) Patent Application Publication
(10) Pub. No.: US 2002/0013174 A1
(43) Pub. Date: Jan. 31, 2002

(54) Method and system for interactive advertising

(76) Inventor: Kiyoshi Murata, Denver, CO (US)

Correspondence Address: Kiyoshi Murata, Unit 305, 930 Acoma Street, Denver, CO, 80204, US

(21) Appl. No.: 09/870,966

(22) Filed: May 31, 2001

Related U.S. Application Data
(60) Provisional application No. 60/208,114, filed on May 31, 2000.
(60) Provisional application No. 60/270,341, filed on Feb. 21, 2001.

(51) Int. Cl. A63F 13/00

(52) U.S. Cl. 463/42; 463/1; 463/16; 705/1; 705/14

(57) ABSTRACT

A method and system for providing interactive advertising through a game over a computerized communications network wherein advertisers receive greater consumer awareness while the consumers (game registrants) enjoy the gaming experience without having the advertisements being an intrusive interruption.

### CROSS REFERENCES TO RELATED APPLICATIONS

This application claims the benefit of U.S. Provisional Application Serial No. 60/208,114, filed on May 31, 2000 and U.S. Provisional Application Serial Number 60/270,341, filed on Feb. 21, 2001.

### FIELD OF THE INVENTION

This invention relates to the field of advertising, and more particularly to communication systems providing interactive advertising.

### BACKGROUND OF THE INVENTION

There used to be a time when, businesses (such as retailers) had real customer relationships. They knew their customers personally, understood what they wanted, and, as best they could, satisfied the customers needs through old fashion personalized service. This approach earned them loyalty and a large share of their customers' business. However, the personalized service was costly and inefficient, and for better or worse eventually gave way to mass marketing when customers traded relationships for greater variety and lower prices.

Businesses are once again beginning to realize that their most valuable asset is the information they possess on customers and their buying patterns. Competitiveness increasingly depends on the quality of decision-making. The ability to improve the knowledge about customers, their buying patterns and markets will enable businesses to better target their advertising, products and services.

Demographic information (data), the statistical characteristics of human populations, such as age, gender, and income, are especially useful for identifying consumer markets for goods and services. Once collected, the demographic data provides an invaluable marketing tool for businesses. Information including economic data, age, gender, social type, employment, housing type, lifestyle, expenditure habits and other related data is used to support a wide range of business decisions, such as creating targeted strategies for marketing campaigns.

Banner advertising “click-through-rates” have steadily decreased to less than ½% of the viewers of the banner ad, and continue to fall. The targeted consumers do not wish to be interrupted from their current task and thus have learned to ignore the banner ads. Thus advertisers are seeking new ways to gain the attention of targeted consumers. Expansive television advertisements while potentially effective are costly to produce and air.

Therefore, there is a need for a method and system to reliably present advertising information to a targeted consumers group.

### SUMMARY OF THE INVENTION

The present invention is a method of providing interactive advertising in the form of a game over a computerized communications network.

### BRIEF DESCRIPTION OF THE DRAWINGS

A more complete understanding of the present invention may be obtained from consideration of the following description in conjunction with the drawings in which:

FIG. 1 is a stylized overview of interconnected computer system networks;

FIG. 2 is a high level view of the interrelationship of a game registrant to a zing/zicon bank;

FIG. 3 is a high level view of the personalization and categorization of the relationship of a game registrant to an advertiser;

FIG. 4 is a first exemplary screen from a trivia game;

FIG. 5 is a second exemplary screen from a trivia game;

FIG. 6 is a third exemplary screen from a trivia game; and, FIG. 7 is a high level over view of the interrelationship of advertising to various games.

### DETAILED DESCRIPTION OF VARIOUS ILLUSTRATIVE EMBODIMENTS

Although the present invention, a method for providing interactive advertising through a game over a computerized communications network, is particularly well suited for use in connecting Internet users and shall be so described, the present invention is equally well suited for use in other network communication systems such as an Intranet, Interactive television (iTV) and similar interactive communication systems.

The Internet is a worldwide system of computer networks—a network of networks in which users at one computer can obtain information from any other computer (and communicate with users of the other computers). The Internet was conceived by the Advanced Research Projects Agency (ARPA) of the U.S. government in 1969 and was first known as the ARPANet. The original aim was to create a network that would allow users of a research computer at one university to be able to communicate with research computers at other universities. A key design element of ARPANet that, because messages could be routed or rerouted in more than one direction during the course of a communication link, the network could continue to function even if parts of it were destroyed such as by a military attack or natural disaster.

The Internet has evolved into a public, cooperative, and self-sustaining facility accessible to hundreds of millions of people worldwide. Physically, the Internet uses a portion of the total resources of the currently existing public telecommunication networks. Technically, what distinguishes the Internet is its use of a set of protocols called Transmission Control Protocol/Internet Protocol (TCP/IP).

For many Internet users, electronic mail (e-mail) has essentially all but replaced the Postal Service for short written transactions. E-mail is the most widely used application on the Internet. Live “conversations” can be carried on with other computer users, using Internet Relay Chat (IRC). More recently, Internet telephony hardware and software allows real-time voice conversations.

The most widely used part of the Internet is the World Wide Web (often abbreviated “WWW” or called “the Web”). The most outstanding feature of the Web is its use of hypertext, which is a method of instant cross-referencing. In most Web sites, certain words or phrases appear in text of a different color than the rest; often this text is also underlined. When one of these words or phrases is selected, it's a hyperlink, transferring the user to the site or page that is relevant to this word or phrase. Sometimes there are buttons, images, or portions of images that are “clickable.” Using the Web provides access to millions of pages of information. Web “surfing” is done with a Web browser; the most popular of which presently are Netscape Navigator and Microsoft Internet Explorer. The appearance of a particular Web site may vary slightly depending on the particular browser used. Recent versions of browsers have plug-ins, which provide animation, virtual reality, sound, and music.

Because the Internet evolved from the ARPAnet, a research experiment that supported the exchange of data between government contractors and (often academic) researchers, an on-line culture developed that is alien to the corporate business world. Although the Internet was not designed to make commercialization easy, various forms of e-commerce have rapidly evolved. Setting up e-commerce provides low overhead while reaching a worldwide market 24 hours a day. The growth and popularity of the Internet is providing new opportunities for commercialization including but not limited to Web sites driven by electronic commerce, ad revenue, branding, database transactions, and intranet/extranet applications.

Domain names direct where e-mail is sent, files are found, and computer resources are located. They are used when accessing information on the Web or connecting to other computers through Telnet. Internet users enter the domain name, which is automatically converted to the Internet Protocol address by the Domain Name System (DNS).

E-mail was one of the first services developed on the Internet. Today, e-mail is an important service on any computer network, not just the Internet. E-mail involves sending a message from one computer account to another computer account. E-mail is used to send textual information as well as files, including graphic files, executable files, word processing and other files. E-mail is becoming a popular way to conduct business over long distances. Using e-mail to contact a business associate can be faster than using a voice telephone, because the recipient can read it at a convenient time, and the sender can include as much information as needed to explain the situation.

On-line commerce, or “e-commerce”, uses the Internet, of which the Web is a part, to transfer large amounts of information about numerous goods and services in exchange for payment or customer data needed to facilitate payment. Potential customers can supply a company with shipping and invoicing information without having to tie up sales staff. The convenience offered to the customer is that they don't have to drive around town all day looking for the product they want.

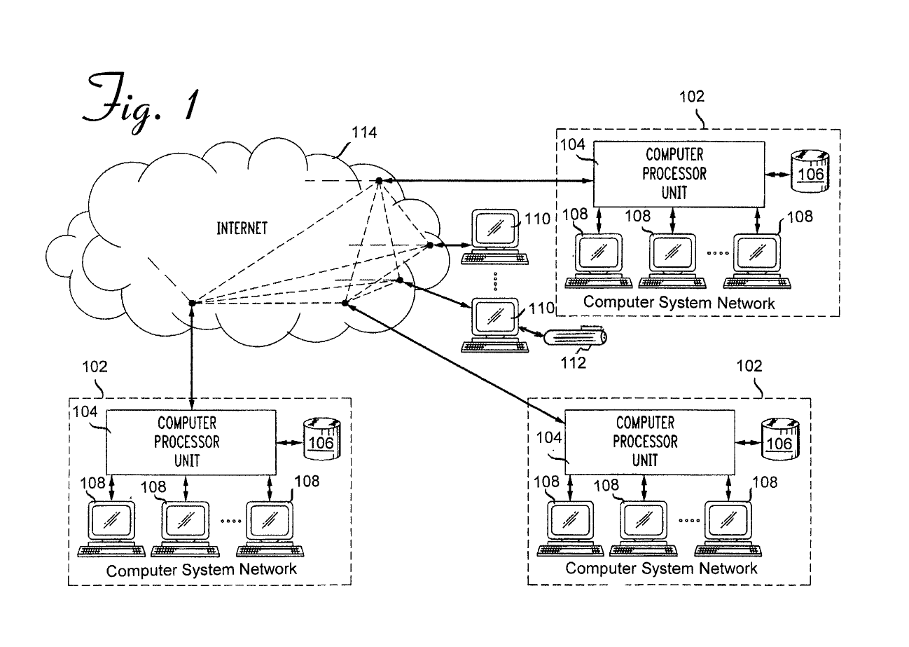

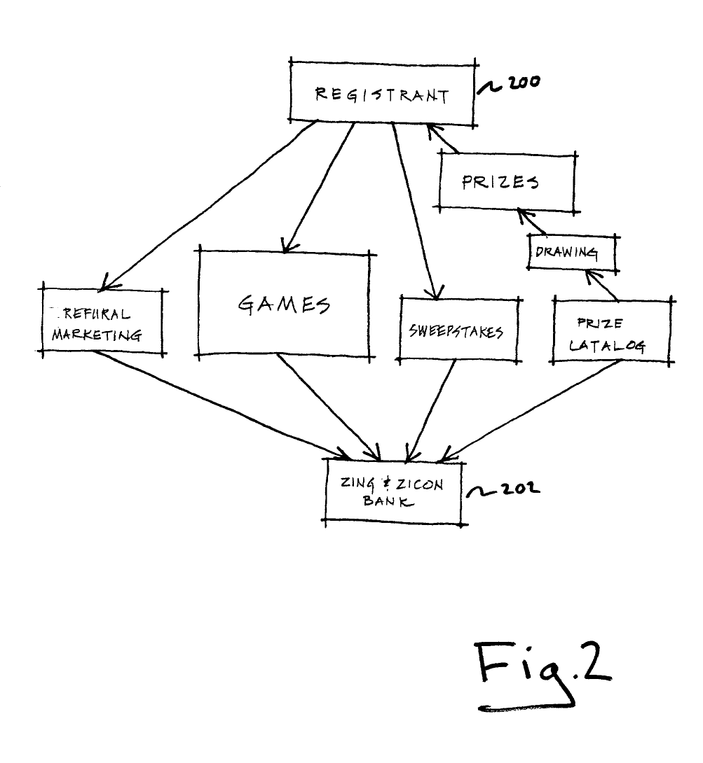

Referring to FIG. 1 there is shown a stylized overview of interconnected computer system networks. Each computer system network 102 contains a corresponding local computer processor unit 104, which are coupled to a corresponding local data storage unit 106, and local network users 108. The local computer processor units 104 are selectively coupled to a plurality of users 110 through the Internet 114. Each of the plurality of users 110 may have various devices connected to their local computer systems such as scanners, bar code readers, RFID detectors and other interface devices 112. A user 110 locates and selects (such as by clicking with a mouse) a particular Web page, the content of which is located on the local data storage unit 106 of the computer system network 102, to access the content of the Web page. The Web page may contain links to other computer systems and other Web pages.

The present invention, method for providing interactive advertising through a game over a computerized communications network described herein sets to solve three major hurdles, which are:

1) limited size of the web sites, 200,000 to 5,000,000 Unique Visitors per Month, (UVM) must be made larger to make Internet advertising more effective;

2) huge acquisition cost of web site registrants must be reduced as current business plans and the available funding will not support such a high customer acquisition cost; and,

3) advertisements must be presented in a way that the audience will absorb them, as interruption advertising is not working effectively.

In one embodiment of the present invention, method for providing interactive advertising through a game over a computerized communications network, content in the form or Internet games is provided. Four exemplary games (more games can be added by one skilled in the art) are packaged (grouped together) as one set of “XYZing Games.” This content is offered free to existing sites (Host Sites) that have significant number of registrants.

The Host Site's registrants are able to play the XYZing Games without leaving the Host Site. In one embodiment, the registrants will be playing the games from a file created for the Host Site in the XYZing.com server.

This embodiment is beneficial to Host Sites in several ways:

1. no initial or ongoing charges;

2. additional content increasing stickiness;

3. increased revenue from all other advertisements due to added hang-time;

4. decreased user migration loss;

5. immediate revenue through banner ads on XYZing game pages (such as 75% to Host Site, 25% to XYZing; and,

6. primary revenue through a Prize Catalog advertisement sale.

By adding an unlimited number of Host Sites, XYZing shall generate a large aggregate number registrants playing the various XYZing Games. This aggregate number is projected to be at least 20-30 million UVM. With this scale of users, Advertisers enjoy large exposure through a single source. This method solves the need described in 1 and 2 above. This method creates a large audience base without the huge acquisition cost.

Briefly, everyone playing the XYZing games wins points. XYZing keeps track of each individual player, including: their points, game playing habits, catalog viewing, and profile. Game players are able to redeem their points at the XYZing Catalog. The catalog is an electronic catalog with approximately 20 pages of advertisements. The registrant submits points for a drawing of the things they would like. The approximately 20 pages will be selected based on the profile demographics, so the advertisers will really be “pointing” to their “customer base.” Because the registrant is opting to see the pages (to choose a prize) this is “permission advertising” rather than the “interruption advertising”.

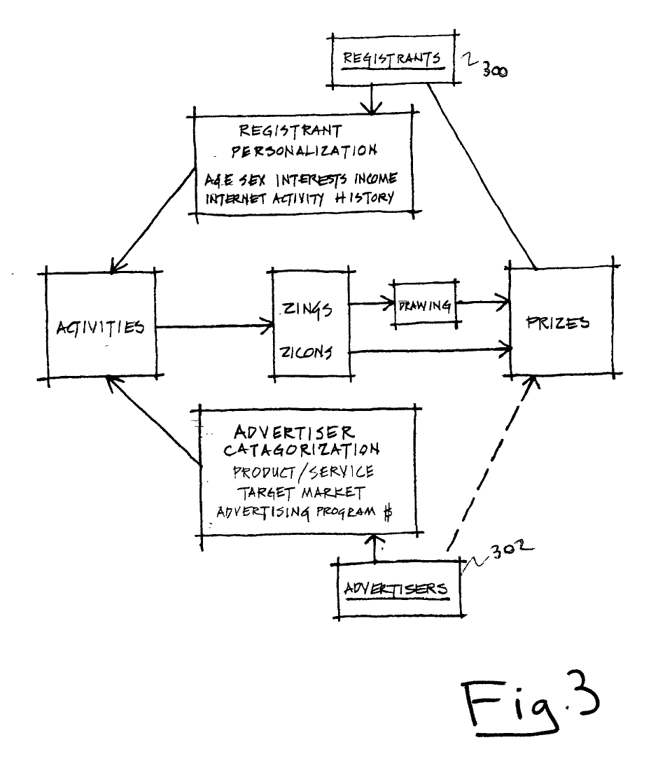

The present invention, method for providing interactive advertising through a game over a computerized communications network, is an enhanced method of Intra-Ad™ (advertising system that integrates logos, images, tag lines and messages within the user participation of the electronic medium), which provides a new platform for advertising on the Internet. This new business methodology integrates the advertising into computerized games. To play a game, a registrant interacts with a specially designed game that incorporates logos, icons and various advertising messages. By interacting with the advertising, the registrant gains meaningful recognition of a brand, while earning points or tokens, which serve as a reward and motivator. The advertisers receive greater consumer awareness while the consumers (game registrants) enjoy the gaming experience without having the advertisements being an interruption. The games are examples of the Intra-Ad™ advertising, where participants become familiar with products and brands, by in many instance, seeking out a particular brand to help navigate through the games. Referring to FIG. 2 there is shown a high level view of the interrelationship of a game registrant 200 to a zing/zicon bank 202. While one (embodiment of the present invention, method for providing interactive advertising through a game over a computerized communications network, utilizes a website offering a variety of games, the present invention is equally well suited for presentation in other forums, with optional links to other games or a centralized web site. The centralized web site provides a variety of games and informational content, which are interwoven with a structured system of advertisements. A game registrant interacts with various advertisements as they play the game. During the play of a game, the registrant earns points (Zings) or tokens (Zicons) in response to playing a game that is selected by a registrant. The particular choice of games, or the content (advertising as well as underlying game type and details) associated with the game structure can be dynamically varied in response to the specific demographics of the game registrant and further modified by the play actions of the game registrant. Points and tokens are accumulated and saved for a registrant, enabling their later redemption as well as immediate redemption.

The game registrant can “cash in” their points (Zings) by selecting items from a prize catalog. Prizes include physical merchandise as well as digital content (screen savers, utilities, and, games), which may be down loaded. As an advertiser is identified with a unique token (Zicon), game registrants need to collect specific tokens (Zicons) in order to win prizes particular prizes. Game registrants are thus motivated to collect a particular token (Zicons) that they need. The, tokens (Zicons) can represent the advertisers by miniature illustration of their product or use of their logos.

The prize catalog is tailored to feature a number of lifestyle products that appeal to the particular demographics of the game registrant. Additionally, the prize catalog selections can change based on the accumulated points, displaying numerous items within reach of a particular game registrant, while only displaying a limited number of higher value “teaser” items. The price catalog can be tailored by a rule-based system or by the use of an intelligent agent. Utilizing an intelligent agent, the particular prizes and even their placement and prominence (size, active images, etc.) can be tailored for a particular game registrant based on their specific demographics, group/class demographics as well as actual game selection and responses.

An intelligent agent must have the capability to take actions leading to the completion of a task or objective, such as accessing the prize catalog database and game registrant demographics etc., without trigger or input from an end-user or system administrator. The details of the programming of the intelligent agent are known to those skilled in the art. The functioning and design of intelligent software agents are described in “Software Agents: An Overview” by Hyacinth S. Nwana, Knowledge Engineering Review, Vol. 11, No.3 pp 1-40, September 1996 and “Intelligent Agents: A Technology And Business Application Analysis” by Kathryn Heilmann et al., URL: http://www -iiuf.unifr.ch/pai/users/chantem/heilmann, 1998, which are herein incorporated by reference.

The programmatic implementation is well suited for coding in various languages including but not limited to Java, HTML, XTML, Cold Fusion, C++, etc. The integration of advertising logos, text, and icons as part of playing the games is done using computer software and hardware at a server/source web site and is identified by a URL. A game registrant logs onto the web server site using their email address and password to authenticate their identity.

The present invention, method for providing interactive advertising through a game over a computerized communications network, is well suited for implementation on a server architecture. Accessing the server/source web site can be done from a personal computer, specialized web browser, web TV, wireless Internet communication device as well as personal digital assistants.

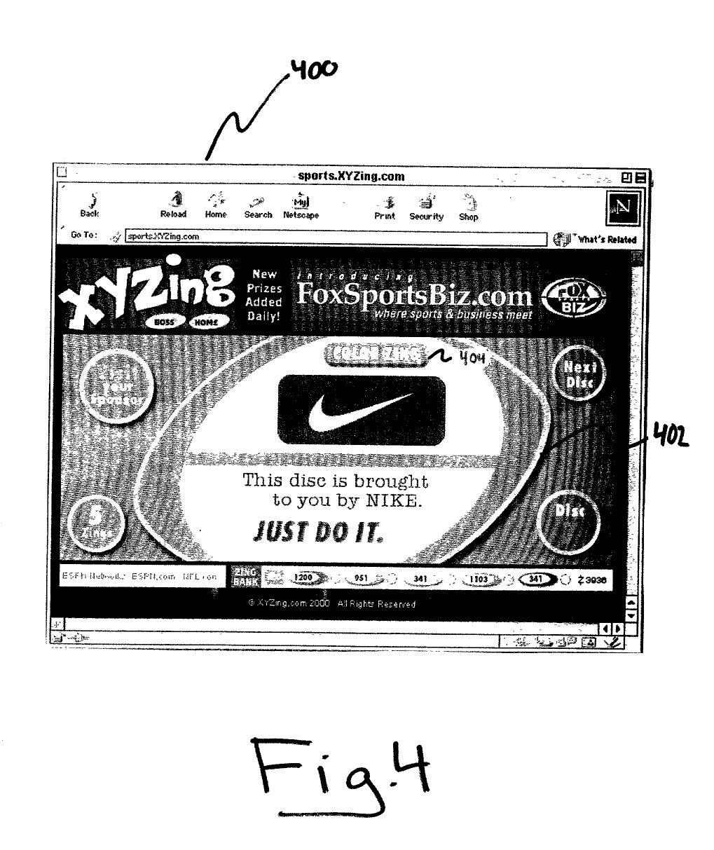

The system architecture is designed to be completely scalable, thus being able to service millions of registrants. The initial system will be at a single collocation site, but the design can be spread across multiple geographically separated collocation sites using load balancing switches such as those available from Alteon, Cisco, FS Labs, and other sources. The web servers are load shared using the same load balancing switches. The web servers are front ended by web accelerators and other caching servers to provide optimum performance. The web servers run a Cold Fusion application (or other suitable software) and serve up dynamic html pages. The web servers all have dual NICs (Network Interface Cards) to maximize performance and prevent I/O contention between the web service and database access. The database runs on one or more multiprocessor systems running the Microsoft Windows 2000 Server operating system and Microsoft Sequel Server Database application Software or other suitable systems. For expansion the system can utilize multiple processors, be move to Oracle Database software, or to a larger database server. The present invention, method for providing interactive advertising through a game over a computerized communications network, has a number of unique requirements that necessitate high speed computing, decision making, data tracking, and data display. The present invention is fully interactive and highly personalized to each registrant's interests, and each advertisers target demographic market. Gathering, recording and indexing data on each registrant over time such as age, income level, hobbies and other interests, does this. Survey questions can utilize click on multiple choice responses or simple yes-no so that only one answer per question will be recorded. Some of the responses can be fill in the blanks. A question such as “do you play team sports” would then prompt a new series of questions, such as a selection of sports to check off from. The system would then close the new question and move back up a level. For a positive response to “are you a student?”, would further qualify the question such as asking college or graduate school with additional for majors, years already completed, etc. Marital status provides queries for single, divorced, widowed, married. Referring to FIG. 3 there is shown a high level view of the personalization and categorization of the relationship of a game registrant 300 to an advertiser 302.

A “cookie” can be placed on the computer of the game registrant containing information for subsequent use. The game registrant may be pre-qualified. A representative example of pre-qualification includes selecting users of a particular type of consumer product, attending a school in a particular area, etc. When a game registrant is being pre-qualified, they may be directed to a particular surveyor specific game option based upon their initial pre-qualification response or responses.

Some sports events odds can be obtained from other vendors, while some games require Sports Events Odds calculations based on the actual wagers made by a game registrant.

Referral marketing tracking is needed to calculate winnings distributions for the multiple tiers of people who sign up other people under our incentive sign up system. For a large number of people signed up this calculation can get to be substantial.

Database transactions are a fundamental mechanism that is used to determine who did what when, how much they won or lost and why, and allows for a Customer Service organization to answer questions of people about what has happened and to resolve any issues where there may be bugs in the computer programs. Some representative examples of transaction tracking include: Account management, login logout times, and activity while online, validation that a person is who they say they are. Tracking wagering is done to determine winners and losers. Tracking zings is done to let registrants know where they stand in the overall wins and losses. Sweepstakes winner random selection is also done by the computer system to insure that it is done on an impartial basis.

The following are various illustrative embodiments, which employ the present invention method and system for focused advertising (“interplay advertising”) as applied to a web based game-site. The activities and games on the web based game-site are designed toward registrants inning prizes by accumulating one or both of two “currencies”, zings (points) and zicons (tokens).

In one embodiment, there are five different color zings (points), which represent five denominations of zings (points). Game registrants must collect number of specific colors (denomination) in order to win prizes. Game registrants are thus motivated to collect specific color that they need. Particular advertisers are assigned one of the five colors (denominations) of a zing (point), based on their choice of five advertising dollar levels.

In another (embodiment, zicons (tokens) are awarded to game registrants. Each advertiser will be identified with a unique zicon. Game registrants need to collect a specific type, number and/or sequence of zicons in order to win prizes. Game registrants are thus motivated to collect a particular zicons that they need.

Illustrative games that employ the zings (points) and zicons (tokens) follow. The games on a particular game based web site can all be related to sports and thus directed at sports fans. While the present invention, method for providing interactive advertising 10 through a game over a computerized communications network, is well suited for sports related games, and is so described, it is equally well suited for other common interest themes, such as soap operas, music videos, movies, and other mass appeal themes.

The games are related to one another in terms of its content, point earnings, and award prizes. This interrelationship encourages the game registrants to participate in several different games and increases their game playtime at the web site. Advertisers are invited to participate in a package for the game web site, rather than as a sponsor of one or the other games. In addition to the package, the advertisers will have special events and independent promotional opportunities, including linking from the advertiser's web site directly to a customized game.

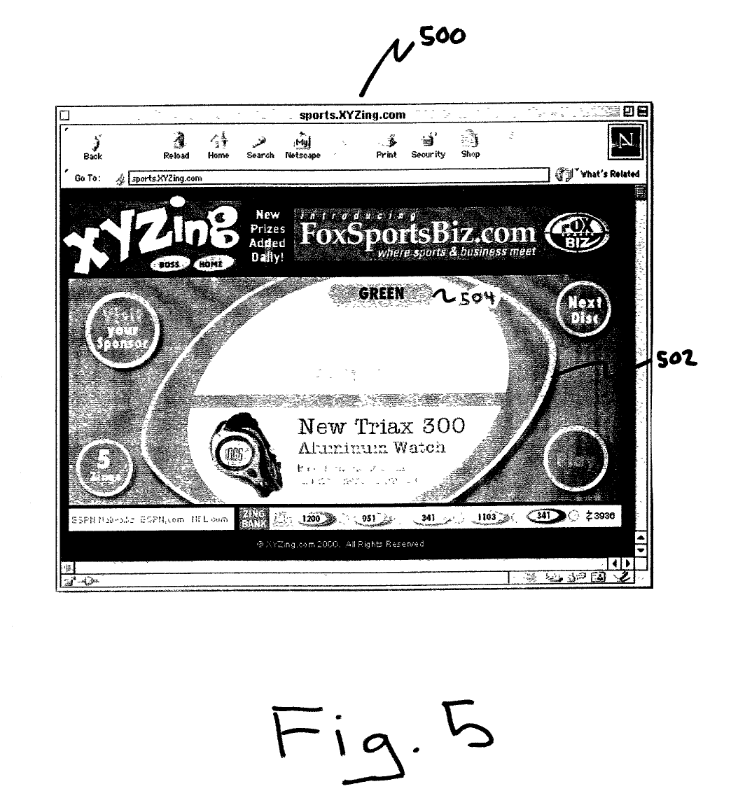

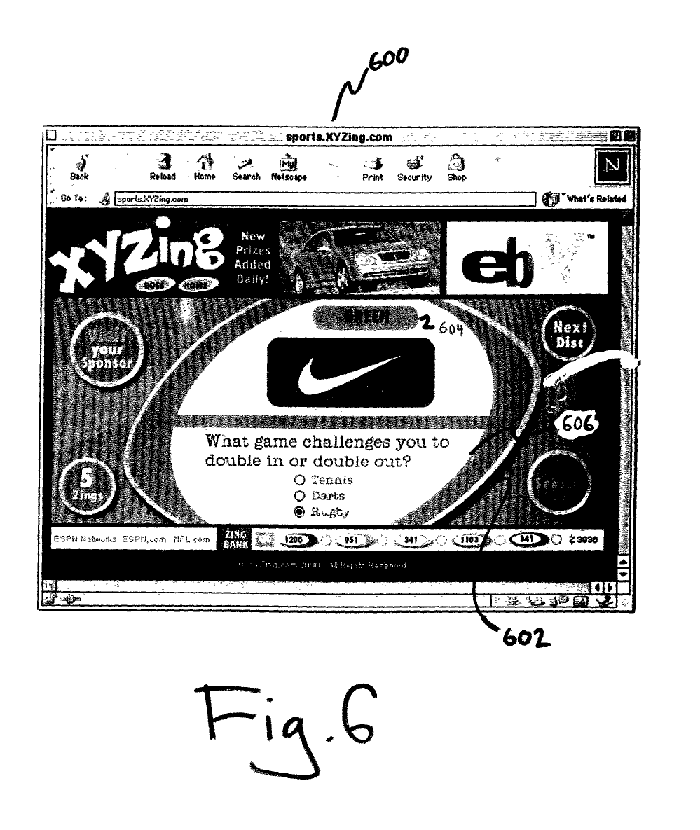

Trivia Disc is a game is based on the registrants answering sports related trivial questions. Each question is presented on a disc (a page). Referring to FIG. 4 there is shown a first exemplelry screen display 400 in which a disc 402 will display a sponsor logo and sport category, but will not reveal the question, the color of zings (points), or the zicon (token) to be won. Game registrant clicks on the “color zing” button 404 to determine the color of the zing (point) that the game disk 402 will represent. Game registrant clicks on the logo and, as can be seen in FIG. 5 on a second exemplary screen display 500, the disc 502 is turned over to display the color zing (point) 504, the zicon (token), together with an additional tag line from the same advertiser. The game registrant may click on a disc. The game registrant has the option for passing or playing based on their need for the particular color zing (point). If the game registrant chooses to select that color zing (point)/zicon (token) and the disc 502 will turn over again.

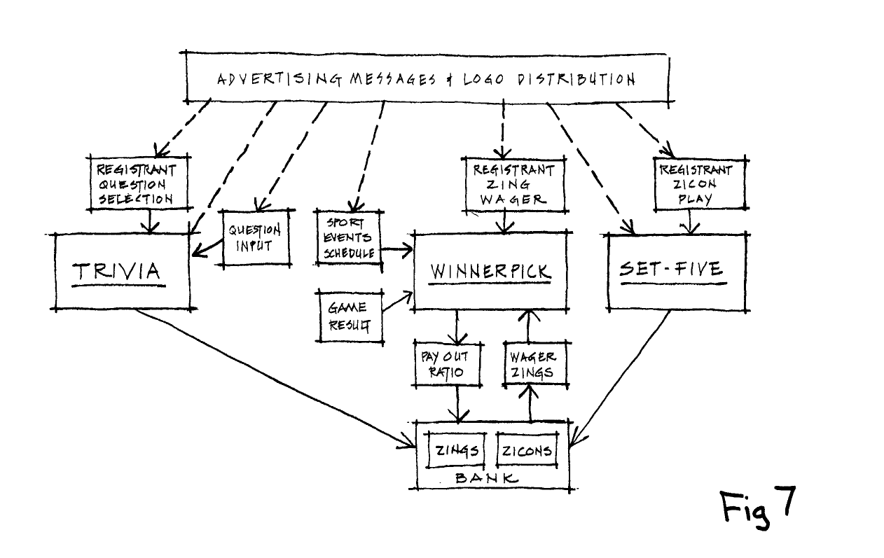

Referring to FIG. 6 there is shown a third exemplary screen 600. This time, the disc 602 will carry a third image from the advertiser, the color zing (point) 604 and a multiple- choice question 606. The value of award zings (point) per question increases with the number of questions the game registrant answers correctly (a progressive point system). The game registrant is also awarded the zicon (token) for each question answered correctly.

Set Five is a game that is played with the zicons (tokens) that the game registrants can win while participating in other games. In one embodiment, the Set-Five board consists of one hundred squares created by 10 rows by 10 columns formed by a grid. Each square contains one zicon (token) image of a sponsor. The object of the game is to place the collected zicons (tokens) to fill the corresponding square to form a “set” of five squares in a row. The set may be formed vertically, horizontally, or diagonally. As the board starts to fill, the game registrant is motivated to seek specific zicons (tokens) that he requires to complete his sets. When the game registrant forms 5 sets on one board, he is a winner.

Every ten days, a new Set-Five board will be issued. Each board has a limited life, such as 30 days. Each board depicts the prize that the game registrant will obtain if the game registrant wins. In this game the prizes are awarded to the first 1,000 entrants that forms 5 sets. This adds an element of time for the registrants to log on regularly and complete the game in the shortest time. The prizes can be progressively awarded, with prizes of increasing value (or more choices) to the first group of winners, such as the first 10 entrants, then the first 100 entrants, and finally the first 1000 entrants.

The zicon (token) images are placed randomly on the boards. However, the number of each sponsors' zicon (token) images are strictly controlled to match the appropriate sponsor levels of funding.

Playing Forum is a game based on the registrants selecting the winning team corresponding to current sports events. Each current sports game is presented on a disc. A disc will display a sponsor logo and the two teams, but will not reveal the color of zings (points) or the zicon (token) to be won. Game registrant clicks on the logo and the disc will turn over to display the color zing, the zicon (token), together with an additional tag line from the same advertiser. The registrant may click on the disc, if registrant chooses to select the: color zing (point)/zicon (token) and the disc will turn over again. This time, the disc will carry a third image from the advertiser and the registrant may wager, up to 10 zings (points) on his selected team. The game registrant may wager only 20 the same color zing (points) as the color of zing (point) represented by the disc. The award number of zings (points) for selecting the winning team will vary depending on the total number of registrants wagering on the game and the proportion of wagering on each team. The registrant is awarded the zicon (token) for each winning team that was selected.

Independent of particular games, advertising sponsors have opportunities to offer to the game registrants, free zings (points) and/or zicons (tokens) for their demographic profile information, permission for e-mail communication, and or other promotional activities.

The prizes for the games are offered in a “catalog” of ten specially featured products and services. The zings (points) are used to enter into drawings of anyone or more prizes. Each prize is offered in a full-page presentation giving the product manufacturer to take full advantage of the marketing opportunity. The registrants learn about the product in order to make his selection. The “price” to enter the drawing varies with the value of the prizes. The “price” consists of specific combination of colors determined, by the proportion of advertiser sponsor levels. Referring to FIG. 7 there is shown a high level over view of the interrelationship of various games with advertising messages and advertiser logos.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications, which come within the scope of the appended claim, is reserved.

What is claimed:

1. A method for presenting advertising through a game over a computerized communications network, the method comprising:
identifying a game player;
providing an interactive game over the computerized communication network; presenting advertising content integrated within the game; and,
rewarding the game player corresponding to game performance; wherein the advertising content is a part of the game whereby the advertising content does not interrupt the game player.

2. The method as recited in claim 1 further comprising the step of collecting demographic information corresponding to the game player.

3. The method as recited in claim 1 wherein the step of rewarding further comprises providing a catalog of prizes.

4. The method as recited in claim 1 wherein the game corresponds to a common theme.

5. The method as recited in claim 3 wherein selecting from the catalog of prizes results in entering a drawing for a particular prize.

6. The method as recited in claim 1 wherein the step of providing an interactive game uses an aggregate of web sites.

7. The method as recited in claim 6 wherein the aggregate of webs sites provides a uniform presentation of advertising content to the game player.

8. The method as recited in claim 1 further comprising the step of collecting game player preference information.

9. The method as recited in claim 1 further comprising the step of collecting game history specific to the game player.

10. The method as recited in claim 9 wherein presenting advertising content within the game is a function of game history specific to the game player.

11. A system for aggregating potential consumers over computerized communications network comprising:
an interactive game to be accessed over the computerized communication network by a game player;
means for presenting advertising content integrated within the game to the game player; and,
means for rewarding the game player corresponding to game performance; wherein the advertising content is a part of the interactive game whereby the advertising content does not interrupt the game player.

12. The system as recited in claim 11 further comprising means for collecting demographic information corresponding to the game player.

13. The system as recited in claim 11 wherein the means for rewarding the game player uses a catalog of prizes.

14. The system as recited in claim 11 wherein the interactive game corresponds to a common theme.

15. The system as recited in claim 13 further comprising means for selecting from the catalog of prizes by entering a drawing for a particular prize.

16. The system as recited in claim 11 further comprising means for aggregating web sites using the interactive game.

17. The system as recited in claim 16 wherein the aggregate of webs sites provides a uniform presentation of advertising content.

18. The system as recited in claim 11 further comprising means for collecting game player preference information.

19. The system as recited in claim 11 further comprising means for collecting game history specific to the game player.

20. The system as recited in claim 19 wherein presenting advertising content within the game is a function of game history specific to the game player.
